(19) United States
(12) Patent Application Publication
(10) Pub. No.: US 2006/0235903 A1
(43) Pub. Date: Oct. 19, 2006

(54) Method and system for retrieving deleted and overwritten documents

(76) Inventor: Rajesh Kapur, Toronto (CA)

Correspondence Address: Rajesh Kapur, 264 Huntsmill blvd, Toronto, ON, M1W 3G6, CA

(21) Appl. No.: 11/335,790

(22) Filed: Jan. 20, 2006

Related U.S. Application Data
(63) Continuation of application No. PCT/CA05/00977, filed on Jun. 22, 2005.

(30) Foreign Application Priority Data
Apr. 14, 2005 (CA) 2,504,070
May 5, 2005 (CA) 2,506,167
Sep. 20, 2005 (GB) 0519238.0
Aug. 18, 2005 (GB) 0516995.8

(51) Int. Cl. G06F 17/30

(52) U.S. Cl. 707/202

(57) ABSTRACT

A method, system for preserving access to deleted and/or overwritten documents for the retrieval in a system, wherein said document data is stored in a system filestore associated with a system database containing reference data to point to the document within the system filestore, the method comprising the steps of: determining that a delete/overwrite command has been issued; recording the reference data prior to or after deleting or updating of the reference data; inserting the recorded reference data in a set of access-preservation tables; and providing the set of access-preservation tables to hold the combined and separated reference data, which points to the deleted and overwritten documents within the filestore.

### FIELD OF INVENTION

This invention relates to a improved method, system for capturing, storing, preserving access to documents and metadata associated in a Document Management System in regards to both the delete and overwrites of a document version and the separation of the documents into those deleted by means of a delete action and those by an overwrite action. In the case of erroneously deleted files, but now has also been applied for the purpose of intentionally deleting files for the purpose of archival and/or migration.

### BACKGROUND TO THE INVENTION

The present invention relates to a method and system for capturing and recovering documents or versions of whether intentionally deleted and or overwritten within a Document Management System.

### BACKGROUND OF INVENTION

Many large companies use document management software. Document Management software is fairly recent and was released onto the market place in the late 1990's. The purpose of such software is to help companies keep track of large volumes of documents in an organized way, so that documents can be easily stored, found and retrieved. In many cases, there will be more than one version of a particular document. Thus, version control is another aspect of most document management systems. Version control is an issue of particular importance in situations where different people are able to share documents and have shared access to the documents, including a shared right to independently modify the documents.

One example of a company in which a document management software system would be useful is an engineering company that has many versions of the same part. When a client orders that part the company has to find the correct part version.

The document management system typically includes a system database that is associated with a filestore. The filestore stores the actual document data, while the system database stores reference information that points to the document within the filestore. Also, the system database typically stores supplementary document information regarding each document.

As part of the management of documents, documents get deleted from the filestore, or a particular version of the document gets overwritten by a new version. However, in some cases, the deleting or overwriting gets done in error, with valuable information within the document, or the previous version thereof, being lost in the process. When this happens, it is desirable for the user to be able to get his original document back. However, often, by the time the user realises that he needs his original document back, the document management system has run a standard clean-up routine that makes it effectively impossible

to retrieve the deleted or overwritten file. Clean up routines are required because if the system database is not cleaned up every so often to account for deletion and overwriting of documents, inconsistencies can arise in the system database information, which can eventually lead to corruption of the filestore.

Another scenario is that documents continue to grow greatly in these systems, and companies need, over time to migrate to new systems or simply just archive data off to normal disk storage.

So intentional deletes need to be caught in order to hive of data to disk or migrate.

Documentum™ is a document management system that comprises of three different layers (or technologies) sitting on top of an operating system (server based) such as Unix™ or Windows 2000™ server, a system database, and a filestore.

The layers comprise of a Documentum™ application server layer that sits on top of the database and serves Documentum™ client interfaces. The reference information (i.e. the information pointing to the physical document data) and supplementary document information (i.e. the attributes of the types of Documents stored) are stored in the database. The actual physical data is stored in a filestore on either the server, a Storage area network (SAN) or Filer pointed to by the server.

It would therefore be desirable to have a method and system that allows users to retrieve deleted and/or overwritten documents being managed by a document management system.

A deleted document refers to any or all versions of a document selected to be deleted, it is important to note here that the physical file is not deleted in the first case, but certain metadata associated with the representation or image of the file, clean up jobs later remove the other associated.

A overwritten document refers to a user “checking out” the document and saving the document as the same version (thereby losing the previous content of the document) checking in by accident or by design as the same version of the document as the document that is being modified, thereby the prior document, is overwritten. Sometimes this prior work is still required, especially if the document is being worked on by two people and one person looses his work because a second person removes a clause, or, the part is slightly different in a new model of car. If the process is however, is completely reversed the new document can be lost. The user therefore has the option through this invention to return the document as a new document of the same name, or indeed to replace the document that replaced it.

The invention has the advantages that the documents and versions of that are intentionally or unintentionally deleted can on requirement be caught and sent to the authorised user on request, together with any salient information stored against that document if required. A second technical advantage of this invention in the case of the Documentum™ document management system is that the deletes do not need to be captured and processed before the updates. A third advantage is that documents can be intentionally deleted caught and hived off to disk. Document management systems are fairly recent, and this facility is a useful, and necessary addition.

One aspect of the present invention provides a better method for preserving access to deleted or overwritten documents within a document management system, wherein said document data is stored in a system filestore associated with a system database containing reference data to point to the document data within the system filestore, the method comprising the steps of:
determining that a delete/overwrite command has been issued;
recording the reference data after deleting or updating of the reference data;
inserting the recorded reference data in a set of access-preservation tables; and
combining, the set of access-preservation tables with data in the system provide metadata on and pointer to the deleted/overwritten document data encrypted within the filestore.

Another aspect of the present invention provides a system for preserving access to deleted or overwritten document data, comprising: a database for storing reference information and supplementary document information; at least one trigger for catching and recording reference data that has been deleted and/or updated from the database; at least one access preservation table for storing access preservation data, the access preservation data being operable to point to the data that has been deleted and/or updated; and at least one stored procedure to combine data captured in the at least one access preservation table.

Preferably, the reference data is contained within three system tables in the system database, and wherein the recording step comprises the step of recording reference data from said three system tables.

The system can, in response to a delete/overwrite command, delete, update reference data from first system table, delete from a second system table and update reference data to a third system table.

Preferably, the system comprises a Documentum™ document management system, and wherein the first system table comprises a dm_sysobject_s table, the second system table comprises a dm_sysobject_r table, and the third table comprises a dmr_content_r table.

Preferably, the reference data comprises object identification data from the first table, version identification data from the second table, and a parent identification within the third table, wherein the parent identification can be joined to a fourth table which points to the document data in the system filestore.

Preferably, the system comprises a Documentum™ document management system and wherein the fourth table comprises a dmr_content_s table. Preferably, the recording step comprises recording the reference data using at least one database trigger.

Preferably, the recording step comprises recording the reference data using a first and second database trigger associated with the first table, a database Oracle™ trigger associated with the second table, and a fourth database trigger associated with the third table.

Preferably, the set comprises a first second access-preservation table to receive reference data recorded from the first system table, a third access-preservation table to receive reference data recorded from the second system table, and a fourth access preservation table to receive reference data recorded from the third system table.

Preferably, the method further comprises the step of using the reference data from the access preservation data to obtain supplementary document information, related to the deleted/overwritten document, from system tables.

Preferably, the supplementary document information includes information selected from the following group: a name of the document deleted or overwritten, a folder within the system database from the document was deleted or overwritten, a storage identification of the deleted/overwritten document that indicates the position of storage within the filestore, a parent identification of the deleted/overwritten document to permit checking of the document path within the filestore, an object identification to provide filestore path information, a type of object that was deleted/overwritten, a version of the deleted/overwritten document and a date that the document was deleted/overwritten.

Preferably, the method further comprises combining the access-preservation table and the supplementary document information into a combined table.

Preferably, the combining step comprises combining prior to the system executing a method that cleans the system tables to prevent access to supplementary document information for deleted/overwritten documents from the system tables.

Preferably, the system comprises a Documentum™ document management system, and wherein the method is carried out by a dm_clean routine.

Preferably, the recording, inserting and providing steps are executed by the execution of Oracle™ software code. Preferably, the recording, inserting and providing steps are executed by the execution of SQL Server™ software code.

An example of an embodiment of the invention will now be described in detail with reference to the accompanying drawings in which:

### DRAWINGS

FIG. 1 is a schematic diagram of a system for preserving access to overwritten documents according to a first embodiment of the present invention.

### DESCRIPTION OF THE INVENTION

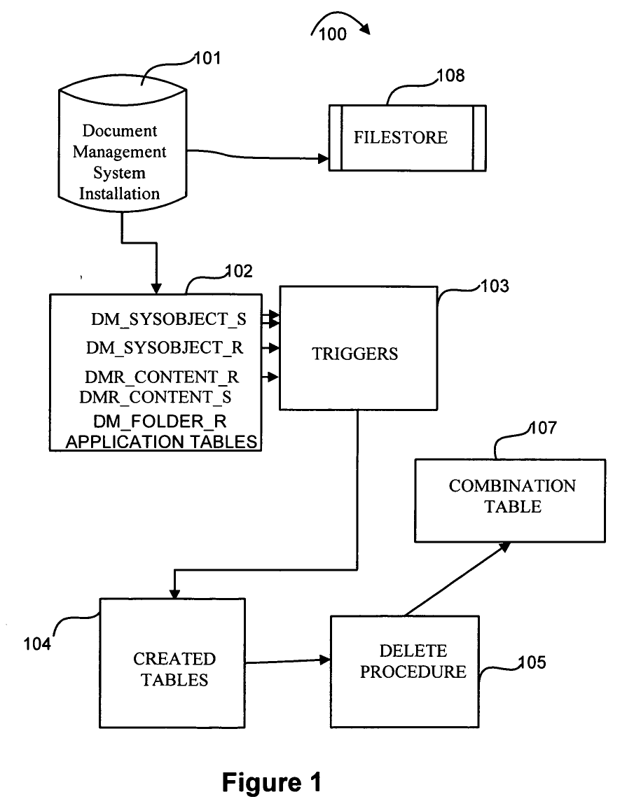

FIG. 1 shows a system 100 according to a first embodiment of the invention, which allows the capture of relevant reference and supplementary document information at the exact time it is deleted or updated by means of Oracle™ database triggers 103. These triggers 103 are added to the relevant Documentum™ tables 102 and they automatically fire to capture the salient information needed to retrieve the pointer information to the physical data for the file. Information is then created in access preservation tables 104, then captured in combination tables 107 by running a delete procedure 105 and/or an overwrite procedure 106.

A typical Documentum™ system database 101 has a number of system tables 102 that store reference information and supplementary document information. These tables 102 include (but are not typically limited to) the dm_sysobject_s table (first table), which stores object IDs for the documents; the dm_sysobject_r table (second table) which stores, inter alia, version IDs for documents; the dmr_content_r table (third table) which stores, inter alia, parent ID needed to find the pointer to the document within the filestore; and the dmr_content_s table (fourth table), which stores an r_object_ID that, together with the parent_ID, determines the pointer to the location of the document within the filestore. The parent_id or r_object_id of the fourth table can also be found in the first table it is the I_contents_id. It is this that is used to combine data in order for overwrites to be captured separately from deletes. Prehaps, even before deletes.

When a document is deleted/overwritten, the relevant reference data from the first tables is deleted and or updated, and the relevant reference data from the third table (including the parent ID) is updated to a Null, or overwritten. The i_contents_id, is similarity overwritten in the first table.

According to one embodiment of the invention, at least one, and preferably four, Oracle™ triggers 103 are used to catch and record the reference data that was deleted and/or updated. These reference data are then inserted into access-preservation tables 104 (preferably one corresponding to each of the four triggere on the three system tables), and the access-preservation data are provided to point to the deleted/overwritten document within the filestore 108.

In the preferred method, the reference data from the access preservation tables 104 is used to obtain supplementary document information, related to the deleted/overwritten document, from the system tables 102 (preferably the first four and the table dm_folder_r). The supplementary document information preferably includes a name of the document deleted or overwritten, a folder within the system filestore 108 from which the document was deleted or overwritten, a storage identification of the deleted/overwritten document that indicates the position of storage within the filestore, a parent identification of the deleted/overwritten document to permit checking of the document path within the system database 102, an object identification to provide filestore path information, a type of object that was deleted/overwritten, a version of the deleted/overwritten document and a date that the document was deleted/overwritten.

The method preferably further comprises the step of combining the access preservation tables 104 and the supplementary document information contained in system 100 using the delete procedure 105 and or the overwrite procedure into a set of at least one combined table 107. This step is preferably performed before the system executes a cleaning of the system tables, because at least some of the supplementary document information will not be available once a cleaning, such as a dm_clean routine, is run.

In typical operation, the data location within the filestore at which a document is located is obtained by combining the parent ID from the third table with the r_object_ID from the fourth table to obtain the data ticket (i.e. the pointer), along with the storage ID which can be used to find the file path of the document on the filestore.

This pointer information can then be translated through commonly available Documentum™ support notes. The Data Ticket and the storage_id (pointer info) are two pieces of data that need to be obtained to help retrieve the document's physical file. The other information required is the r_object_id and the parent_id.

The actual path and filename are typically encrypted within the filestore to protect the document from unauthorized access. To decrypt, support note 310 is used and the parent_id taken from the combination tables 107 described further below; before dm_clean is run, the parent ID is plugged into the Documentum™ APIs shown on the note through the API interface in Documentum™ Administrator.

For example
apply,c, 090106d450cgbs3b, GET_PATH
next,c,q0
get,c,q0,result
This should give you the path of the file on the content store (but this only works before dm_clean is run).

As described below, another Documentum™ support note can also be used to calculate the full file path and name of the document stored on the server. This is done using the r_object_id, storage_id and Data_ticket (all values contained in the combination tables This alternate calculation of the file path and name can be compared with the above calculation using note 310 to increase the probability that the correct file path and name are known. Once dm_clean has been run, the note 310 calculation will not work, but the alternate calculation will function to find the exact place on the server or backup tape at which a deleted file resides. The method of the present invention can then be used from the time of successful comparison of the two name and path calculations. i.e. by running the procedures below automatically through either a Cron/ or Veritas job.

When an object or document is deleted or overwritten, the parent_id of the document is updated and set to Null. Once this occurs there is no way to link the dmr_content_r table to the dmr_content_s table. The purpose of the recording of reference information was, inter alia, to ensure that the parent ID was recorded in order to get storage location and data ticket.

Below, there is shown sample code implementing this portion of the invention. Code is given for both Oracle™ and SQL Server™ (For Delete is for older versions). The invention can be implemented in a multi-database embodiment.

Oracle ™
create or replace trigger capture_del_s_trigger
before delete on dm_sysobject_s
for each row
Begin
kapurture_del_s(:old.r_object_id,:old.r_object_type,:old.object_name);
EXCEPTION
when others then
RAISE;
END;
/
create or replace trigger capture_i_trigger
before update on dmr_content_r
for each row
Begin
kapurture_del_i(:old.r_object_id,:old.parent_id);
EXCEPTION
When others then
RAISE;
END;
/
Create or replace trigger capture_del_r_trigger
before delete on dm_sysobject_r
for each row
Begin
kapurture_del_r(:old.r_object_id,:old.r_version_label,:old.i_folder_id);
EXCEPTION
when others then
RAISE;
END;
/
create or replace trigger capture_upd_s_trigger
after update on dm_sysobject_s
for each row
Begin
Insert into capture_upd_s_table (r_object_id,
r_object_type,object_name,r_version_label,
I_contents_id,i_folder_id,date_saved)
Select
:old_r_object_id,:old_r_object_type,:old.object_name,r_version_label,:old.icontents_id,
i_folder_id, sysdate
from dm_sysobject_r
where r_object_id = :old.r_object_id
and r_version_label != ‘current’;
EXCEPTION
when others then
RAISE;
END;
/
then Sql Server ™:-
create trigger capture_del_r_trigger
on dbo.dm_sysobject_r
After Delete --FOR Delete
as
if exists ( insert into capture_del_r_table values (r_object_id, r_version_label,
i_folder_id)

select r_object_id, r_version_label, i_folder_id from deleted where

r_object_id in (select r_object_id from deleted)

)

Go
create trigger capture_i_trigger
on dbo.dmr_content_r
After Update --FOR Update
as
if exists ( insert into capture_i_table values (r_object_id, parent_id)

```
  select r_object_id, parent_id from deleted where
  r_object_id in (select r_object_id from deleted)
)
```

go
create trigger capture_del_s_trigger
on dbo.dm_sysobject_s
After Delete --FOR Delete
as
if exists ( insert into capture_del_s_table values (r_object_id, r_object_type,
object_name,date_saved)

select r_object_id, r_object_type, object_name,getdate( ) from deleted

where

r_object_id in (select r_object_id from deleted)

)
Go
create trigger capture_del_s_trigger
on dbo.dm_sysobject_s
After Update --FOR Delete
as
if exists ( insert into capture_del_s_table values (r_object_id, r_object_type,
object_name,I_contents_id,r_version_label,i_folder_id,date_saved)
select deleted.r_object_id, deleted.r_object_type,
deleted.object_name, deleted.i_contents_id, dm_sysobject_r.r_version_label,
dm_sysobject_r.i_folder_id, getdate( )
from deleted inner join dm_sysobject_r
on deleted.r_object_id = dm_sysobject_r.r_object_id
where deleted.r_object_id in (select r_object_id from deleted)
and dm_sysobject_r.r_version_label <> ‘current’
)

Go

In the the dm_sysobject_s and dm_sysobject_r tables, a “after row delete” is preferably used, meaning the data that has been deleted is captured. For the dmr_content_r table, a “before update row” is preferably used, meaning that the data to be updated is captured. This ensures that all salient and/or relevant information is captured.

It will be appreciated that an “after row delete” and “after row update” could also be used and are comprehended by the invention. In such a case, the old values are captured immediately upon the deletion or update.

The reference data is trapped (i.e. recorded) and inserted into four tables:—

create table capture_i_table (
r_object_id varchar2(16),
parent_id varchar2(32),
date_saved date)
/
create table capture_del_s_table (
r_object_id varchar2(16),
r_object_type varchar2(32),
object_name varchar2(255),
date_saved date)
/
create table capture_upd_s_table (
r_object_id varchar2(16),
r_object_type varchar2(32),
object_name varchar2(255),
date_saved date)
/
create table capture_del_r_table (
r_object_id varchar2(16),
r_version_label varchar2(32),
i_folder_id varchar2(16))
/

More columns for extra data can of course be added to these tables, but the preferred method comprises recording the salient reference data from three tables.

The procedures, given the names RKapurture_del_data.plb and RKapurture_upd_data.plb, then are used to combine the access-preservation tables with the dmr_content_s table to produce the combination tables and to get the all important data_ticket value which must be converted to a char using to_char(data_ticket) as well as combining other data.

The combination tables 107 could take the form of a single table for both deletes and overwrites. However, it is preferred that there be a combination table for deletes and one for overwrites.

create table capture_del_ro_table (
date_deleted date,
storage_id varchar2(16),
data_ticket varchar2(20),
full_format varchar2(64),
r_object_id varchar2(16),
r_object_type varchar2(32),
object_name varchar2(255),
r_version_label varchar2(32),
r_parent_id varchar2(32),
r_folder_path varchar2(255))
/
create table capture_upd_ro_table (
date_deleted date,
storage_id varchar2(16),
data_ticket varchar2(20),
full_format varchar2(64),
r_object_id varchar2(16),
r_object_type varchar2(32),
object_name varchar2(255),
r_version_label varchar2(32),
r_parent_id varchar2(32),
r_folder_path varchar2(255))
/

Once the storage_id, data_ticket, r_object_id, parent_id are available in the above tables the method of the present invention is preferably to run the procedures every night and just before dm_clean runs. This will ensure that all of the necessary reference data is captured.

The following is the “alternate” process referred to above for calculating the file path and name. Take the storage_id obtained and use it as the r_object_id into the table dm_store_s. This should give you the filestore concerned (there could be more than one filestore, which collectively act as the “filestore” for the document management system. The path of the filestore can be found through the Documentum™ administrator Part of the file path on the filestore is stored as a hex code. The first part of this hex code is usually contained within the r_object_id of the deleted row corresponding to the deleted document. The remainder of the filepath can be obtained by converting the data_ticket from dec to hex using the dword function on the standard scientific calculator on Microsoft windows, as the support notes will indicate.

For example if you have a data ticket say -2147561899 this converts into 75FECE55 . . . i.e the path to the file could look something like this c:\filestore1\docbase_name\00\06d450\75\FE\CE\55 where 55 is the file name on the server and 0006d450 comes from the r_object_id.

Once the formula for the file paths has been worked out by comparing with the above API method then a plsql routine could even be written to give this automatically.

Basically once the path is known and the date is known, the document that was deleted or overwritten can be retrieved from a Backup tape if it has been cleaned off the server. This is because the path and name are known, so the tape copy of the filestore can be used to locate the deleted/overwritten file.

The preferred mode of installation and execution of the method is as follows. Proceed to the sql prompt of the respective database and the docbase user account.

Once this has been done using the command “sqlplus username/password” the tables can be added at the sql prompt.

sql>@cre_tables.sql

then add the following .plb procedures.

sql>@kapurture_del_i.plb

sql>@kapurture_del_r.plb

sql>@kapurture_del_s.plb

sql>after which add the three triggers

sql>@trigger.sql

and then the two procedures R_kapurture_del_data.plb and

Rkapurture_upd_data.plb

as so

sql>@Rkapurture_del_data.plb

sql>@Rkapurture_upd_data.plb

all you then need to do as everything else is automatic is sql>exec Rkapurture_del_data sql>exec RKapurture_upd_data

As described above, these procedures should be run before the dm_clean routine is run, and preferably each night, alternatively they an be run automatically to separate out the deleted and overwritten documents, int the combination tables.

It will be appreciated that variations in and modifications to the embodiments described and illustrated may be made within the scope of this application.

1. A improved method for preserving access to deleted and overwritten documents within a system, to allow their identification, separation and manual recovery in case the document or document data was deleted or overwritten in error, wherein said document is stored in a system filestore associated with a system database or store that contains reference data to point to the document data within the system filestore, the method comprising the steps of:
determining that a delete or overwrite command has been issued;
recording the reference data prior to or after the deleting or updating of the reference data;
inserting the recorded reference data into a newly added set of access preservation store or tables; and
combining and separating deleted and overwritten data by means of automatically run procedure(s) to combine all other salient reference data connected with the reference data before system reference and documents are cleaned; and
providing at least one but preferably two access-preservation/combination tables the first to point to the deleted documents, and version of; and
second to point to overwritten documents and versions of within the filestore.

2. A method as claimed in claim 1, wherein the reference data is contained in system tables in the system database, and wherein the recording step comprises the step of recording reference data from said system tables.

3. A method as claimed in claim 2, wherein the system, in response to a delete/overwrite command, deletes and or updates reference data from system tables.

4. A method as claimed in claim 3, wherein the system, in response to a delete/overwrite command, deletes and or updates reference data from first and second system tables and updates reference data from a third system table.

5. A method as claimed in claim 1 or claim 4, wherein the system comprises a document management system, and wherein the first system table comprises a dm_sysobject_s table, the second system table comprises a dm_sysobject_r table, and the third table comprises a dmr_content_r table.

6. A method as claimed in claim 2, claim 3, claim 4 or claim 5, wherein the reference data to be recorded from the system tables comprises object identification data, version identification data, and parent identification, wherein the parent identification points to the document in the system filestore.

7. A method as claimed in claim 6, wherein the reference data comprises object and parent identification data from the first table, version identification data from the second table, and a parent identification within the third table, wherein the parent identification can be joined to a fourth table dmr_content_s which points to the document data in the system filestore.

8. A method as claimed in any one of claims 1 to 7, wherein the identifying and determining step comprises automatically recording the reference data using actions stored within at least one database trigger that fires when a delete or overwrite transaction occurs.

9. A method as claimed in any one of claims 4 to claim 7, wherein the recording step comprises recording the reference data using a first and second database trigger associated with the first table, a third database trigger associated with the second table, and a fourth database trigger associated with the third table.

10. A method as claimed in claim 4 or claim 9, wherein the set comprises a first and second access-preservation table to receive reference data recorded from the first system table, a third access-preservation table to receive reference data recorded from the second system table, and a fourth access preservation table to receive reference data recorded from the third system table.

12. A method as claimed in claim 1 wherein the method further comprises the step of using the reference data from the access preservation tables to obtain supplementary document information, related to the deleted or overwritten document, from system tables.

13. A method as claimed in claim 1 or claim 12, wherein the supplementary document information includes information selected from the following group: a name of the document deleted or overwritten, a folder within the system database from the document was deleted or overwritten, a storage identification of the deleted/overwritten document that indicates the position of storage within the filestore, a parent identification of the deleted or overwritten document to permit checking of the document path within the filestore, an object identification to provide filestore path information, the type of object that was deleted or overwritten, a version of the deleted or overwritten document and the date and time that the document was deleted or overwritten.

14. A method as claimed in claim 1, claim 12, and claim 13, wherein the method further comprises combining and, using a procedure, the deleted and overwritten documents recorded within the access-preservation tables together with their supplementary document information into at least one combined table, but preferably two, the first being for the deleted documents, the second for the overwritten files.

15. A method as claimed in claim 1 or claim 14, wherein the combining step comprises running, the combining and separating procedure prior to the system executing a method that cleans the system tables to prevent access to supplementary document information for deleted/overwritten documents from the system tables.

16. A method as claimed in claim 15, wherein the system comprises a document management system, and wherein the method is carried out by a periodic clean up routine.

17. A method as claimed in any one of claims 1 to 16, wherein the recording, combining, separating, inserting and providing steps are executed by the execution of database instructions.

18. A system for preserving access to deleted or overwritten document data, from a document management system with the intention of archiving to storage media or to another document management system comprising:
a database for storing reference information and supplementary document information;
at least one trigger for catching and recording reference data that has been deleted and/or updated from the database;
at least one access preservation table for storing access preservation data, the access preservation data being operable to point to the data that has been deleted and/or updated; and
at least one stored procedure to combine data captured in the at least one access preservation/combination table.

19. A system for preserving access to deleted or overwritten document data, from a document management system with the intention of retrieval of a lost document to any storage media or to another another document management system comprising:
a database for storing reference information and supplementary document information;
at least one trigger for catching and recording reference data that has been deleted and/or updated from the database;
at least one access preservation table for storing access preservation data, the access preservation data being operable to point to the data that has been deleted and/or updated; and
at least one stored procedure to combine data captured in the at least one access preservation/combination table.

20. A document management system the document management system containing said system for preserving access to deleted and overwritten documents as claimed in claim 18 or claim 19.
